(19) United States
(12) Patent Application Publication
(10) Pub. No.: US 2013/0175002 A1
(43) Pub. Date: Jul. 11, 2013

(54) PROCESS FOR CREATING INJECTION MOLDED TOP AND BOTTOM CAPS SECURED TO OPPOSITE ENDS OF AN ELONGATED PIPE USED IN A GEOTHERMAL HEAT RECOVERY OPERATION

(71) Applicant: U.S. Farathane Corporation, Auburn Hills, MI (US)

(72) Inventor: Stephen G. Leonard, Waterford, MI (US)

(73) Assignee: U.S. Farathane Corporation, Auburn Hills, MI (US)

(21) Appl. No.: 13/726,875

(22) Filed: Dec. 26, 2012

Related U.S. Application Data
(60) Provisional application No. 61/585,190, filed on Jan. 10, 2012.

(51) Int. Cl. F16L 55/115; F24J 3/08

(52) U.S. Cl. CPC F16L 55/115; F24J 3/08
USPC 165/45; 138/89

(57) ABSTRACT

A pair of top and bottom caps associated with a geothermal pipe. The top cap has a body with a first end face matching an open end configuration of the pipe, the top cap including first and second conduit portions. A bottom cap likewise includes a body with a first end face matching an opposite facing open end configuration of the pipe and an enclosed bottom portion for redirection of downward fluid flow through a first passageway communicating with the first conduit portion to upward fluid flow through a second passageway communicating with the second conduit portion. Additional features include each of the top and bottom caps having first and second arcuate shaped lobes around a cylindrical shaped central sleeve. Each of the top and bottom caps can further be constructed from an injection molding process.

### CROSS REFERENCE TO RELATED APPLICATIONS

The present application claims the priority of U.S. Ser. No. 61/585,190 filed Jan. 10, 2012.

### FIELD OF THE INVENTION

The present invention discloses a pair of top and bottom end caps, typically constructed of an injection molded material, and which are secured to opposite ends of an elongated extruded pipe incorporated into a geothermal heat recovery operation. The configuration of the end caps are such that the top cap includes extending inlet and outlet conduits which communicate respectively with inlet (larger) and outlet (smaller) lobes interfacing with a similar profile established with the top end of the extruded pipe. The bottom cap exhibits a closed profile in which the larger/downward fluid flowing lobe redirects return upward flow through the smaller lobe. Upon embedding the assembly within a ground location in interfacing fashion with a geothermal environment, the assembly provides for temperature alteration of the inner communicated fluid flow prior to delivery of the same to such as a suitable piece of heat expansion and energy transfer equipment, such as for creating electricity.

### DESCRIPTION OF THE RELEVANT ART

The prior art documented with examples of geothermal heat transfer assemblies. As is known in the art, geothermal heat recovery operations (also termed as a geothermal heat pump or ground source heat pump) are known in the art and which can provide for either of heating or cooling by pumping heat to or from a subterranean zone beneath a ground surface and by which the relevant assembly employed uses the earth as a heat source (in the winter) or a heat sink (in the summer). In application, geothermal systems are designed to take advantage of the moderate temperatures in the ground to boost efficiency and reduce the operational costs of heating and cooling systems. Ground source heat pumps are also known as “geothermal heat pumps” although, strictly, the heat does not come from the centre of the Earth, but from the Sun. They are also known by other names, including geo-exchange, earth-coupled, earth energy systems.

An example of a convection enhanced closed loop geothermal heat pump well is shown in US 2010/0326623 and which discloses an energy transfer system for transferring energy between the earth and a facility. A center pipe has a top end and a bottom end disposed within a well bore with a plurality of apertures depicted in the pipe allowing for ingress and egress of groundwater. A pump is disposed within the center pipe for facilitating flow of groundwater through the apertures. A closed source loop is further disposed in the well bore and includes a pipe extending adjacent the center pipe containing a working fluid for absorbing or transmitting thermal energy.

### SUMMARY OF THE PRESENT INVENTION

The present invention discloses a pair of top and bottom caps associated with a geothermal pipe. The top cap has a three dimensional shaped body with a first end face matching an open end configuration of the pipe. The top cap includes first and second conduit portions.

A bottom cap likewise includes a three dimensional shaped body with a first end face matching an opposite facing open end configuration of the pipe and an enclosed bottom portion for redirection of downward fluid flow through a first passageway communicating with the first conduit portion to upward fluid flow through a second passageway communicating with the second conduit portion. Additional features include each of the top and bottom caps having first and second arcuate shaped lobes around a cylindrical shaped central sleeve. Each of the top and bottom caps can further be constructed from an injection molding process.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective illustration of top and bottom caps installed upon an abbreviated length of extruded pipe according to the present invention;

FIG. 2 is an enlarged view in rotated perspective of the top cap in FIG. 1;

FIG. 3 is an illustration of the top cap from a top end perspective and better showing the inlet and outlet flow tubes as well as the grout fill central aperture defined in the top cap;

FIG. 4 is a substantially rotated and end plan view of the top cap and better illustrating the bottom edge profile of the large and small lobes for mating with the top profile edge of the associated extruded pipe, such as depicted in FIG. 1;

FIG. 5 is an illustration of the bottom cap also shown in FIG. 1;

FIG. 6 is an end plan view of the bottom cap and depicting the bottom arcuate inter-communication of the larger and smaller lobes for redirecting the inlet flow downwardly flowing from the larger lobe in a reverse upward direction through the smaller outlet lobe; and

FIG. 7 is an end view of the geothermal pipe depicted in FIG. 1.

### DETAILED DESCRIPTION OF THE PREFERRED EMBODIMENTS

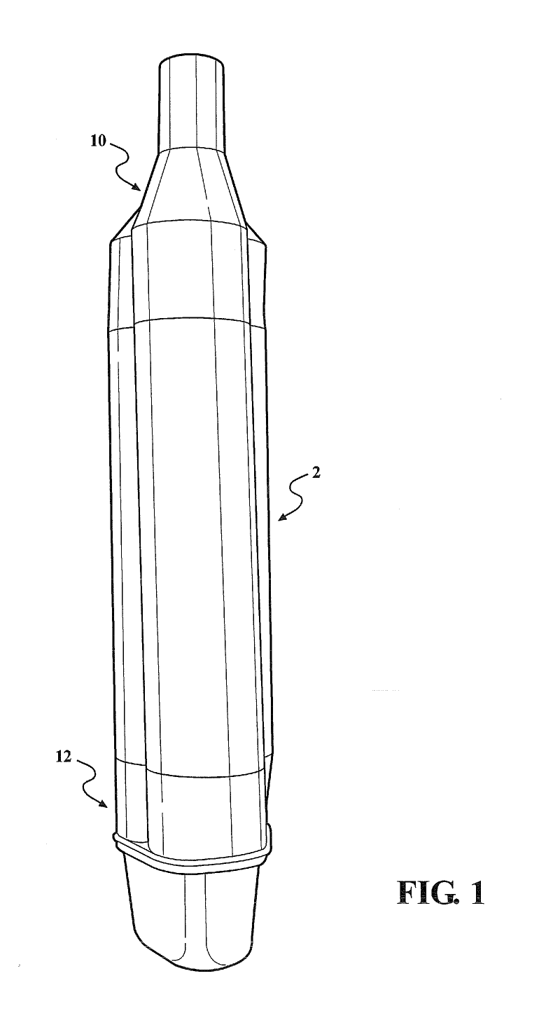

As previously described, the present invention discloses a pair of top 10 and bottom 12 end caps, typically constructed of an injection molded polymeric type material, and which are secured to opposite ends of an elongated extruded pipe 2 incorporated into a geothermal heat recovery operation. As depicted in each of FIGS. 1 and 7, the pipe 2 utilized in a geothermal fluid flow application can, in one non-limited application, be constructed from an HDPE (high density polyethylene) material, it further being understood that any suitable composition of material, combined with any desired heat conductivity characteristics for facilitating efficient thermal transfer from the subterranean location to the closed loop fluid flowing through the conduit interior is contemplated.

The pipe 2 is typically constructed, such as in a continuous co-extrusion process, from a plurality of individual sections, such as which is hot plate welded in end-to-end connected fashion and during emplacement within an underground geothermal gradient environment for modifying a feed temperature of the fluid (typically water). In practice, the fluid is typically warmed (or cooled in the instance of a hot fed water input) to a general temperature range of 57° F., consistent with a typical geothermal gradient occurring within the earth crust and, upon being recovered from an outflow location of the uppermost pipe section, is usually fed into a fluid transfer/heat expansion mechanism for recovering a work output (e.g. electricity).

As best shown in the end view of FIG. 7, the pipe extrusion 10 exhibits a central sleeve shaped and grout receiving tube 3 and such as which is produced in an initial (main) extrusion operation. The central tube 3 includes pluralities of apertures 4 defined at spaced locations therealong and which assist in anchoring the tube within the ground location, such as during the pouring of a cement, grout or other settable material through the central tube 3 and which the apertures 4 permit to completely infill. A pair of outer lobes, each of these including an arcuate formed and elongated layer applied to exterior locations of the central tube 3 is depicted by a first larger lobe 6 and a second smaller lobe 8.

The sizing of the exterior lobes 6 and 8 are further such that the down/inflow lobe 6 exhibits a larger inner area in comparison to the up/outflow lobe 8, this in order to maintain desired directional fluid flow as well as to optimize the thermodynamics associated with the geothermal conditioned fluid delivered to the associated heat transfer (not shown) or other suitable output equipment mounted in fluidic communication with the outflow lobe 8. Also depicted are a pair of recessed side channel profiles, see at 9, through which are exhibited the side apertures or holes 4 in communication with the central sleeve 3, the purpose for which again being the ability to allow a grout fill through the interior sleeve 3 to flow through the outer walls and to fill the exterior of the conduit in the region of the recessed channels to contribute additional positional stability to the assembly when installed below ground.

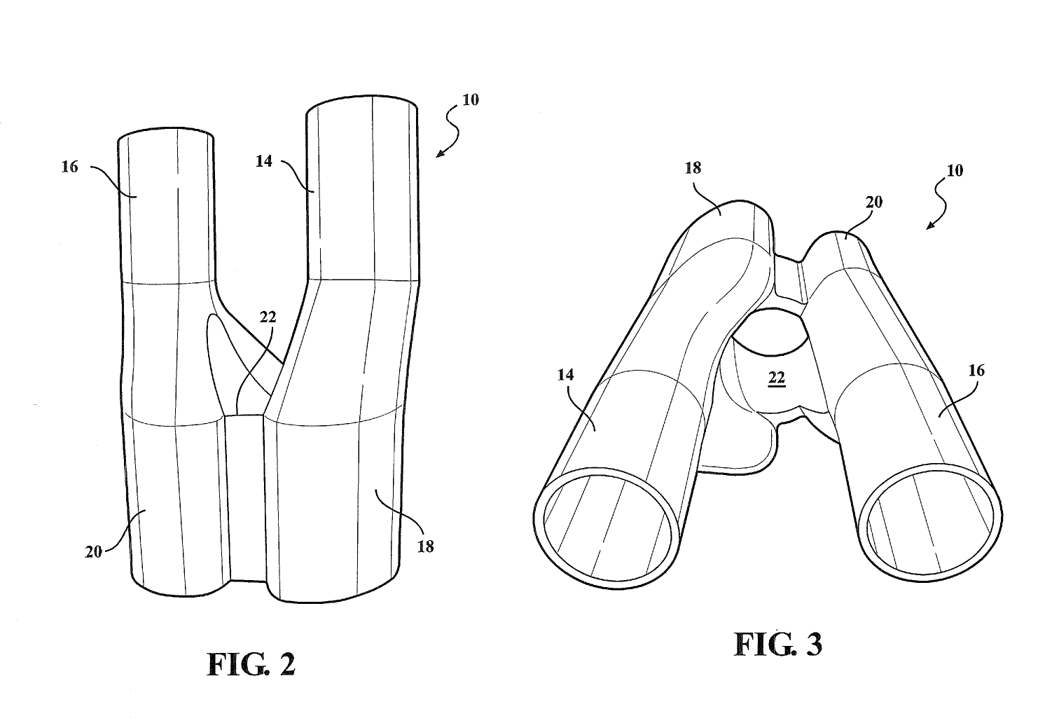

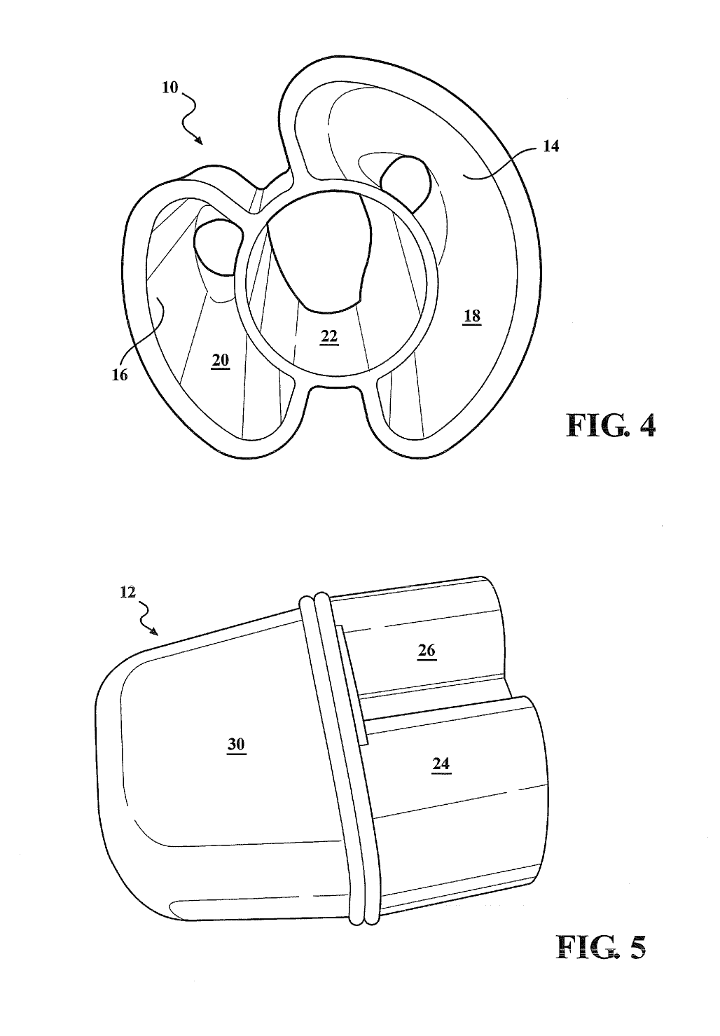

Referring again to FIG. 1, in addition to FIGS. 2-4, a series of perspective and end plan views are shown of the top cap 10 and which includes a first inlet conduit 14 and a second outlet conduit 16, each exhibiting an upwardly configured and internally open portion which respectively conjoins with an internally configured lobe portion 18 and 20 (see FIG. 4) communicable with a generally planar bottom cross sectional profile of the top cap 10. The lobes 18 and 20 as best shown in FIG. 4 extend circumferentially around the central sleeve 22 and are dimensioned so as to match the lobes previously identified at 6 and 8 at the open communicable end of the extruded pipe 2 and, in practice to facilitate the top cap being engaged to the extruded pipe by such as hot plate welding or like affixation process. Although not shown, it is further understood that suitable inflow/outflow pipes are connected over the open ends of the conduits 14 and 16, such as through the application of suitable clamps or other fittings, and in order to both in-feed the raw fluid (e.g. water or water/glycol or other suitable admixture for maximizing convective heat transfer) as well as to retrieve the thermally/convection exposed fluid.

A central sleeve portion 22 is integrally defined in the top cap 10 in like communication with associated central sleeve portion 4 of the extruded pipe 2 and is open at a top fill location to facilitate inflow of grout or the like through the top cap 10 and into the interconnected pipe sections. The top cap 10 depicted in end profile in FIG. 4 accordingly matches that illustrated by the pipe extrusion 2 and, upon being affixed thereto, facilitates both inflow/outflow of fluid through the extending conduit ends 14 and 16.

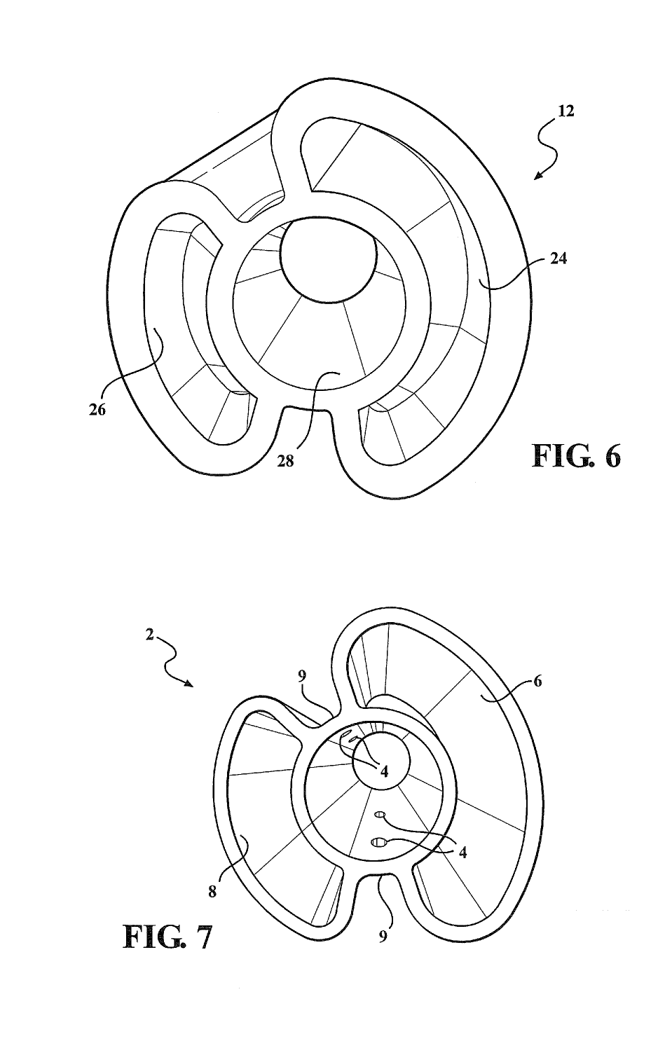

Referring again to FIG. 1 in cooperation with further views of FIGS. 5 and 6, the bottom cap 12 likewise includes a first bottom pipe communicating portion constructed of a larger lobe 24 and a smaller lobe 26, between which is configured a terminating portion of a central sleeve portion 28 (illustrated open but understood to be plugged or closed at a bottom end to prevent flow out of grout into the associated lobes). A closed end cap 30 (FIG. 5) is secured over a lower facing profile edge of the bottom cap 12 and is configured to facilitate communication between bottom arcuate edges of the lobes 24 and 26 such that the down-flow fluid entering the conduit 14 and through the larger interconnected lobes of the top cap 10, pipe 2 and bottom cap 12 is redirected upwardly through the corresponding smaller lobes and eventually outlet the smaller lobe communicating conduit 16 in the top cap.

Although not clearly depicted, the interior configuration of the bottom located end cap 30 is further such that the bottom redirected fluid flow path established between lobes 24 and 26 is not interrupted by the infill of grout into the central sleeve 28. Rather, a central interior location of the end cap 30 is configured to seal the central sleeve 28 of said bottom cap at mating location established therebetween.

Having described our invention, other and additional preferred embodiments will become apparent to those skilled in the art to which it pertains, and without deviating from the scope of the appended claims. This can include such as combining the dies and patterns for creating the outer arcuate lobes 16 and 18 into a single coextruded die component, as well as producing a coextruded article in which the dies are reconfigured for producing a single lobe or other multiple numbers of lobes around the central and initially extruded sleeve.

We claim:

1. A pair of top and bottom caps associated with a geothermal pipe, comprising:
said top cap having an end face adapted to match an end profile of the pipe, first and second separate conduits formed in said top cap adapted to mating with extending conduits within the pipe; and
a bottom cap having an end face adapted to match an opposite end profile of the pipe, first and second conduits in said bottom cap adapted to mating with opposite end locations of the conduits within the pipe; and
an end cap secured to said bottom cap for redirecting a downward fluid flow through said first conduit to an upward return fluid flow through said second conduit for retrieval through said top cap.

2. The invention as described in claim 1, each of said first and second conduits within said top and bottom caps further comprising arcuate shaped lobes extending circumferentially around a central communicating sleeve.

3. The invention as described in claim 1, each of said top and bottom caps further being constructed from an injection molding process.

4. The invention as described in claim 1, each of said top and bottom caps further comprising a high density polyethylene material.

5. The invention as described in claim 2, further comprising said central sleeve in said top cap being open to facilitate in fill of a flowable and settable material into a mating central sleeve associated with the pipe.

6. The invention as described in claim 5, further comprising said central sleeve in said bottom cap being closed off at an inner mating location with said end cap.

7. A geothermal pipe assembly, comprising:
a top cap with first and second separate and integrally defined conduits;
an elongated pipe having first and second conduits extending between first and second opposite ends, said conduits mating upon an end face of said top cap mounting to said first end of said pipe;
a bottom cap having first and second integrally defined conduits mating with said first and second conduits of said pipe upon an end face of said bottom cap mounting to said second end of said pipe; and
an end cap secured to said bottom cap for redirecting a downward fluid flow through said mating first conduits to an upward return fluid flow through said second mating conduits for retrieval through said top cap.

8. The pipe assembly as described in claim 7, each of said first and second conduits within said top and bottom caps further comprising arcuate shaped lobes extending circumferentially around a central communicating sleeve which mates with a further central sleeve integrally defined within said pipe.

9. The pipe assembly as described in claim 7, each of said top and bottom caps further being constructed from an injection molding process.

10. The pipe assembly as described in claim 7, said elongated pipe being constructed from a co-extrusion process.

11. The pipe assembly as described in claim 7, each of said top and bottom caps further comprising a high density polyethylene material.

12. The pipe assembly as described in claim 8, further comprising said central sleeve in said top cap being open to facilitate in fill of a flowable and settable material into said mating central sleeve associated with said pipe.

13. The pipe assembly as described in claim 12, further comprising said central sleeve in said bottom cap being closed off at an inner mating location with said end cap.
